(19) United States
(12) Patent Application Publication
(10) Pub. No.: US 2025/0272682 A1
(43) Pub. Date: Aug. 28, 2025

(54) SYSTEMS AND METHODS FOR AUTOMATED CREATION OF TRANSACTION CLEANSING OVERRIDES

(71) Applicant: Capital One Services, LLC, McLean, VA (US)

(72) Inventors: Aditya Pai, Brooklyn, NY (US); Hao Wang, Montclair, NJ (US); Allison Fenichel McMillan, Brooklyn, NY (US)

(21) Appl. No.: 18/589,538

(22) Filed: Feb. 28, 2024

(51) Int. Cl. G06Q 20/40; G06Q 20/38

(52) U.S. Cl. CPC G06Q 20/4014; G06Q 20/3829; G06Q 2220/00

(57) ABSTRACT

Disclosed embodiments may include a method for automated creation of transaction cleansing overrides. The system may include one or more processors, and memory in communication with the one or more processors and storing instructions that, when executed by the one or more processors, are configured to cause the system to receive a communication from a card holder via one of one or more communication channels and analyze the communication using a first machine learning model to determine an identity of the card holder, detect a mislabeled name, and detect a temporal indicator. In some embodiments, the mislabeled name and the temporal indicator are associated with a transaction. In some embodiments, the memory can be further configured to cause the system to detect card holder records and raw data associated with the transaction; generate a key based on the raw data; and alter an override list to add the key.

The disclosed technology relates to systems and methods for automated creation of transaction cleansing overrides. Specifically, this disclosed technology relates to using a machine learning model to determine correct merchant names to automate the creation of transaction cleansing overrides.

### BACKGROUND

To generate accurate financial statements, typically merchants are required to setup a point-of-sale device, configured to provide merchant code data to financial providers. The merchant code data can be used by financial providers to detect the merchants on financial statements. However, merchant code data can be inconsistent. For example, some merchants insert transaction identification data into the merchant code data, complicating the identification of the merchants. When a merchant is misidentified, financial providers can have difficulty with false fraud reporting of the misidentified merchants. Additionally, if a customer had selected a spending limit associated to a particular merchant, when transactions include mislabeled merchant names, a current spending amount associated with the merchant may be incorrect.

Traditional systems and methods for automated creation of transaction cleansing overrides typically involve manually creating the overrides. However, since the manual overrides require human intervention, it is highly inefficient, time consuming, and costly.

Accordingly, there is a need for improved systems and methods for automated creation of transaction cleansing overrides. Embodiments of the present disclosure are directed to this and other considerations.

### SUMMARY

Disclosed embodiments may include a system for automated creation of transaction cleansing overrides. The system may include one or more processors, and memory in communication with the one or more processors and storing instructions that, when executed by the one or more processors, are configured to cause the system to receive a communication from a card holder via one of one or more communication channels and analyze the communication using a first machine learning model to determine an identity of the card holder, detect a mislabeled name associated with an entry, and detect a date associated with the entry. In some embodiments, the memory, when executed by the one or more processors, are further configured to detect, based on the identity of the card holder, historical entry records of the card holder, detect, based on the historical entry records of the card holder, the mislabeled name associated with the entry and the date associated with the entry, raw entry data associated with the entry, and generate, using a second machine learning model, a key based on the raw entry data. In some embodiments, the memory, when executed by the one or more processors, are further configured to alter an override list to add the key by: determining whether the key substantially matches one of stored keys in the override list and in response to determining the key does not substantially match one of the stored keys in the override list, storing the key in the override list and storing an updated name associated with the key in the override list.

Disclosed embodiments may include a system for automated creation of transaction cleansing overrides. The system may include one or more processors, and memory in communication with the one or more processors and storing instructions that, when executed by the one or more processors, are configured to cause the system to receive a communication from a card holder via one of one or more communication channels and analyze the communication using a first machine learning model to determine an identity of the card holder, detect a mislabeled name associated with an entry, and detect a correct name associated with the entry. In some embodiments, the memory, when executed by the one or more processors, are further configured to detect, based on a plurality of historical entry records, the mislabeled name associated with the entry and the correct name associated with the entry, raw entry data associated with the entry and generate, using a second machine learning model, a key based on the raw entry data. In some embodiments, the memory, when executed by the one or more processors, are further configured to alter an override list to add the key by determining whether the key substantially matches one of stored keys in the override list and in response to determining the key does not substantially match one of the stored keys in the override list, storing the key in the override list. In some embodiments, the memory, when executed by the one or more processors, are further configured to store an updated name associated with the key in the override list.

Disclosed embodiments may include a system for automated creation of transaction cleansing overrides. The system may include one or more processors, and memory in communication with the one or more processors and storing instructions that, when executed by the one or more processors, are configured to cause the system to receive a communication via one of one or more communication channels and analyze the communication using a first machine learning model to detect a mislabeled name associated with an entry and detect a correct name associated with the entry. In some embodiments, the memory, when executed by the one or more processors, are further configured to detect, based on a plurality of historical entry records, the mislabeled name associated with the entry and the correct name associated with the entry, raw entry data associated with a plurality of entries and generate, using a second machine learning model, a key based on the raw entry data. In some embodiments, the memory, when executed by the one or more processors, are further configured to alter an override list to add the key by determining whether the key substantially matches one of stored keys in the override list and in response to determining the key does not substantially match one of the stored keys in the override list, storing the key in the override list. In some embodiments, the memory, when executed by the one or more processors, are further configured to store an updated name associated with the key in the override list.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for automated creation of transaction cleansing overrides in accordance with certain embodiments of the disclosed technology.

FIG. 2 is a flow diagram illustrating an exemplary method for automated creation of transaction cleansing overrides in accordance with certain embodiments of the disclosed technology.

FIG. 3 is a flow diagram illustrating an exemplary method for automated creation of transaction cleansing overrides in accordance with certain embodiments of the disclosed technology.

FIG. 4 is block diagram of an example override identification system used to provide automated creation of transaction cleansing overrides, according to an example implementation of the disclosed technology.

FIG. 5 is block diagram of an example system that may be used to provide automated creation of transaction cleansing overrides, according to an example implementation of the disclosed technology.

### DETAILED DESCRIPTION

Examples of the present disclosure related to systems and methods for automated creation of transaction cleansing overrides. More particularly, the disclosed technology relates to automating the creation of transaction cleansing overrides. The systems and methods described herein utilize, in some instances, machine learning models, which are necessarily rooted in computers and technology. Machine learning models are a unique computer technology that involves training models to complete tasks and make decisions. The present disclosure details analyzing communications from a user using machine learning models to determine the correct name of a merchant of a transaction. This, in some examples, may involve using communication input data and a machine learning model, applied to detecting the card holder, mislabeled merchant name and date associated with a transaction in the communication. Using a machine learning model in this way may allow the system to avoid manually communicating with customers to obtain correct merchant names and adding the correct names to an override list. This is a clear advantage and improvement over prior technologies that use human intervention because human overrides are inefficient and costly. The present disclosure solves this problem by using a machine learning model to determine when a communication relates to misnamed merchants and to extract the data necessary to correct the mislabeled merchant. Overall, the systems and methods disclosed have significant practical applications in the field because of the noteworthy improvements in the creation of overrides using machine learning models and merchant keys, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

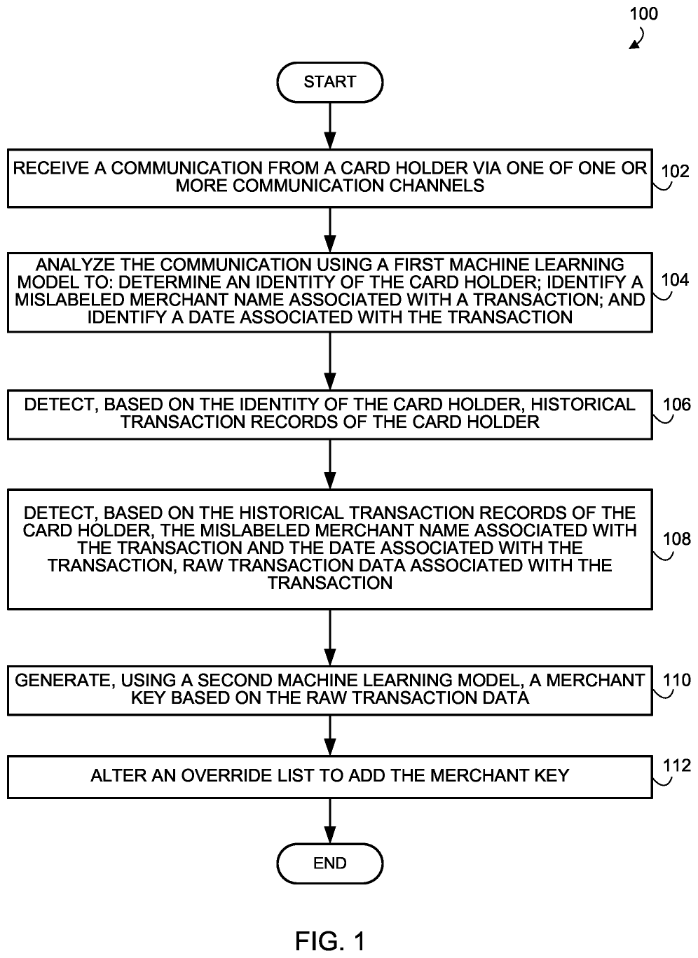

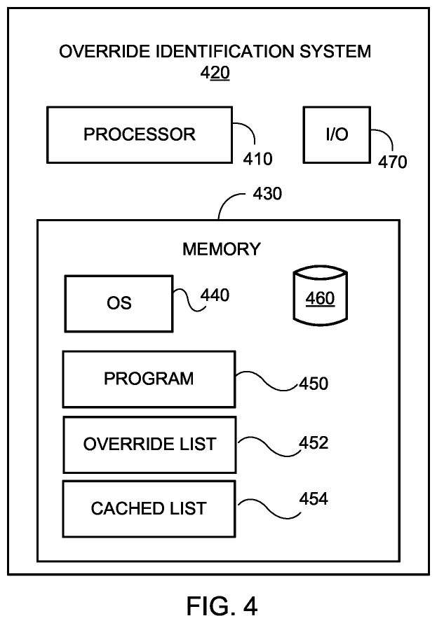

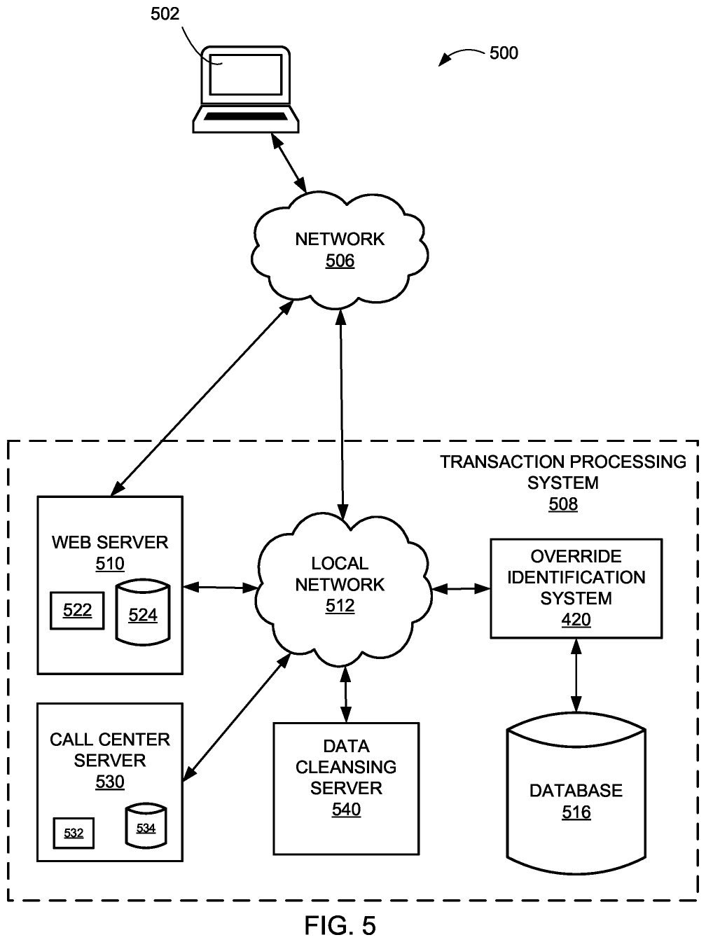

FIG. 1 is a flow diagram illustrating an exemplary method 100 for automated creation of transaction cleansing overrides, in accordance with certain embodiments of the disclosed technology. The steps of method 100 may be performed by one or more components of the system 500 (e.g., override identification system 420 or web server 510 of transaction processing system 508 or user device 502), as described in more detail with respect to FIGS. 4 and 5. It should be understood that certain embodiments of the disclosed technology may omit one or more blocks as being optional.

In block 102, the override identification system 420 may receive a communication from a card holder via one of one or more communication channels. In some embodiments, the one or more communication channels may include one or more of: emails through an email inbox; messages submitted via a website form; chat messages through an application; text messages through a user device 502; and call logs of customer service calls. In some embodiments, the communication can include an email, a message, a chat message, a text message, or a phone call. The override identification system 420 may also utilize other communications and communication channels known in the art.

In block 104, the override identification system 420 may analyze the communication using a first machine learning model to determine an identity of the card holder, detect a mislabeled merchant name associated with a transaction and detect a date associated with the transaction. In some embodiments, the communication may relate to a transaction with a mislabeled merchant. In some embodiments, the override identification system 420 may use the first machine learning model to monitor and analyze the communications submitted via the one or more communication channels in near real time. The first machine learning model may include a large language model that is configured to process a substantive message of the communication to detect the mislabeled merchant name associated with the transaction along with the date associated with the transaction. The large language model may be further configured to process metadata associated with the communication to determine the identity of the card holder.

In block 106, the override identification system 420 may detect, based on the identity of the card holder, historical transaction records of the card holder. The override identification system 420 may extract the historical transaction records from a database. In other embodiments, the override identification system 420 may detect historical communications or historical transaction records from the card holder or other card holders. In other embodiments, the first machine learning model may include a transformer model that has been trained using historical communication data regarding historical transactions associated with misidentified merchants and mapping to corresponding raw transaction data associated with the historical transactions associated with misidentified merchants. The machine learning model may include of the transformer model that has been trained using historical raw transaction data associated with historical transactions that were previously associated with misidentified merchants and corresponding merchant keys stored in the override list.

In block 108, the override identification system 420 may detect, based on the historical transaction records of the card holder, the mislabeled merchant name associated with the transaction and the date associated with the transaction, raw transaction data associated with the transaction. In some embodiments, the raw transaction data may include data stored in one or more merchant data fields. The one or more merchant data fields may include one or more of: a merchant name field; a merchant city field; a merchant state field; a merchant zip code field; a merchant country code field; and a merchant category code. In some embodiments, the override identification system 420 may conduct the identification of the raw transaction data based on a plurality of historical transaction records. In some embodiments, the override identification system 420 may also detect the raw transaction data associated with a plurality of transactions based on the correct merchant name associated with the transaction.

In block 110, the override identification system 420 may generate, using a second machine learning model, a merchant key based on the raw transaction data. In some embodiments, the override identification system 420 may generate the merchant key based on the data stored in the one or more merchant data fields. The one or more merchant data fields may include one or more of: a merchant name field; a merchant city field; a merchant state field; a merchant zip code field; a merchant country code field; and a merchant category code. In some embodiments, the second machine learning model can include a transformer model that has been trained using historical communication data regarding historical transactions associated with misidentified merchants and mapping to corresponding raw transaction data associated with the historical transactions associated with misidentified merchants. The machine learning model may include of the transformer model that has been trained using historical raw transaction data associated with historical transactions that were previously associated with misidentified merchants and corresponding merchant keys stored in the override list.

In block 112, the override identification system 420 may modify or alter an override list to add the merchant key. In some embodiments, the override identification system 420 may compare the merchant key to other merchant keys in the override list. If the merchant key substantially matches a similar key in the other merchant keys, the override identification system 420 may not add the merchant key to the override list. In some embodiments, the override identification system 420 may compare the merchant key to cached keys in the cache when the merchant key does not substantially match one of the other merchant keys. The cached keys in some embodiments may be previous comparisons or matches conducted by the override identification system 420. In some embodiments, when the merchant key substantially matches one of the cached keys, the override identification system 420 may use the corresponding merchant ID from the cache for financial statements or to store in a database. When the merchant key does not match the other merchant keys or cached keys, the override identification system 420, using the machine learning model, may perform a fuzzy search of the plurality of historical transaction records to detect transaction data comprising raw merchant data that is a fuzzy match to the correct merchant name and that corresponds to a customer statement entry associated with the mislabeled merchant name.

In other embodiments, the override identification system 420 may transmit a request to a user device 502 associated with the card holder that asks the card holder to provide an indication of a correct identity of the merchant associated with the transaction; and responsive to receiving a response to the request that includes the indication of the correct identity of the merchant associated with the transaction, modify a statement of the card holder to replace the mislabeled merchant name associated with the transaction with the correct identity of the merchant.

In other embodiments, the override identification system 420 may receive present transaction data. The present transaction data may include transaction data originating from use of a transaction card at a point-of-sale device of a first merchant and represents a transaction that is in the process of attempting to execute. The override identification system 420 may detect a spending restriction policy associated with the transaction card. The spending restriction policy may restrict authorized purchases to one or more predetermined merchants, and the one or more predetermined merchants may include at least a first merchant. The override identification system 420 may determine that the present transaction data includes data corresponding to the merchant key. The merchant key may be associated with the first merchant. Responsive to the present transaction being received prior to a modification of the override list to add the merchant key, the override identification system 420 may decline the transaction and, responsive to the present transaction being received after to the modification of the override list to add the merchant key, transmit a request to a user device 502 associated with the transaction card requesting an identification of the merchant associated with the transaction. Then the override identification system 420 may, in response to receiving an indication from the user device 502 that the merchant associated with the transaction is the first merchant, approve the transaction.

In other embodiments, the override identification system 420 may extract historical transaction records. The override identification system 420 may then determine whether there are similar transaction data to the present transaction data. The override identification system 420 may then verify if at least one of the similar transaction data includes a mislabeled merchant name. The override identification system 420 may then update the mislabeled merchant name in the similar transaction data using the correct identity of the merchant.

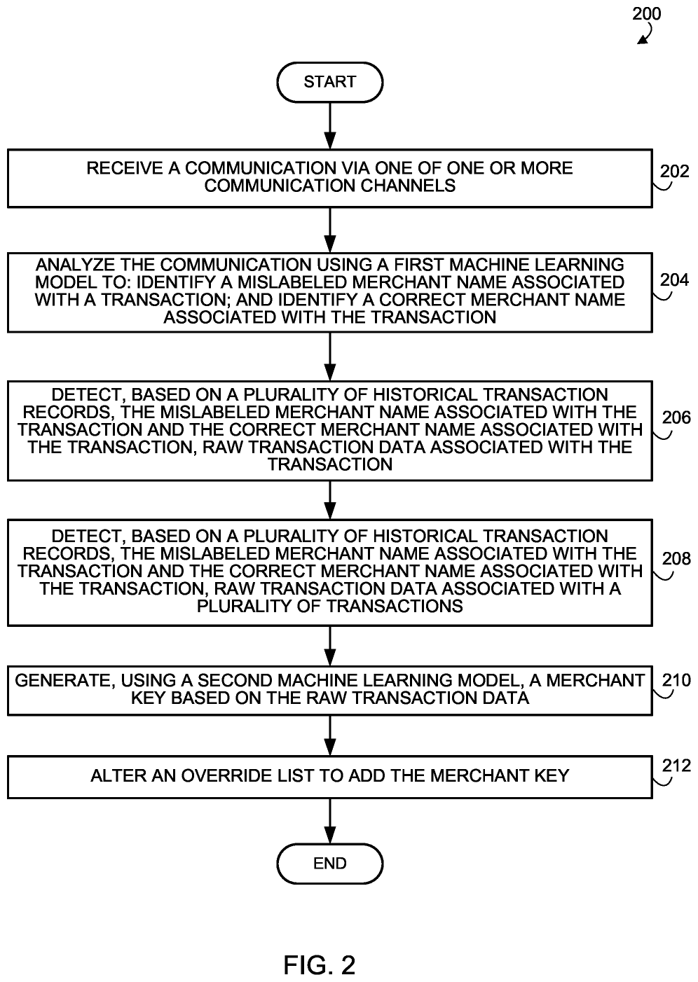

FIG. 2 is a flow diagram illustrating an exemplary method 200 for automated creation of transaction cleansing overrides, in accordance with certain embodiments of the disclosed technology. The steps of method 200 may be performed by one or more components of the system 500 (e.g., override identification system 420 or web server 510 of transaction processing system 508 or user device 502), as described in more detail with respect to FIGS. 4 and 5. It should be understood that certain embodiments of the disclosed technology may omit one or more blocks as being optional.

Method 200 of FIG. 2 is similar to method 100 of FIG. 1. The descriptions of blocks 202, 204, 208, 210, and 212 in method 200 are similar to the respective descriptions of blocks 102, 104, 108, 110, and 112 of method 100 and are not repeated herein for brevity. However, block 206 is different from block 106 and is described below. Additionally, block 208 can be an optional block, unlike block 108 in method 100.

In block 206, the override identification system 420 may detect, based on a plurality of historical transaction records, the mislabeled merchant name associated with the transaction and the correct merchant name associated with the transaction, raw transaction data associated with a plurality of transactions. In some embodiments, detecting the raw transaction data associated with the transaction may include performing a fuzzy search of the plurality of historical transaction records to detect transaction data comprising raw merchant data that is a fuzzy match to the correct merchant name and that corresponds to a customer statement entry associated with the mislabeled merchant name.

In other embodiments, the override identification system 420 may further modify, based on the merchant key, a customer statement comprising the mislabeled merchant name to replace the mislabeled merchant name with one of: raw merchant data derived from the raw transaction data associated with the transaction; and the correct merchant name associated with the transaction.

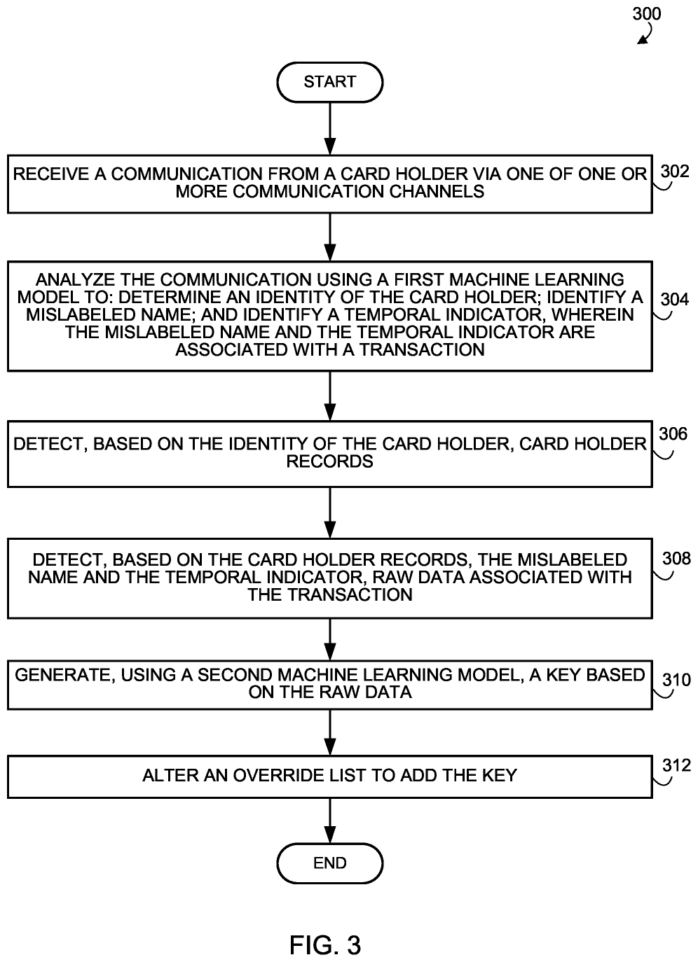

FIG. 3 is a flow diagram illustrating an exemplary method 300 for automated creation of transaction cleansing overrides, in accordance with certain embodiments of the disclosed technology. The steps of method 300 may be performed by one or more components of the system 500 (e.g., override identification system 420 or web server 510 of transaction processing system 508 or user device 502), as described in more detail with respect to FIGS. 4 and 5. It should be understood that certain embodiments of the disclosed technology may omit one or more blocks as being optional.

Method 300 of FIG. 3 is similar to method 100 of FIG. 1. The descriptions of blocks 302, 310, and 312 in method 300 are similar to the respective descriptions of blocks 102, 110, and 112 of method 100 and are not repeated herein for brevity. However, blocks 304, 306, and 308 are different from respective blocks 104, 106, and 108 and is described below.

In block 304, the override identification system 420 may analyze the communication using a first machine learning model to determine an identity of the card holder, detect a mislabeled name and detect a temporal indicator, wherein the mislabeled name and the temporal indicator are associated with a transaction. In some embodiments, the communication may relate to a transaction with a mislabeled name of a merchant. In some embodiments, the override identification system 420 may use the first machine learning model to monitor and analyze the communications submitted via the one or more communication channels in near real time. The first machine learning model may include a large language model that is configured to process a substantive message of the communication to detect the mislabeled name associated with the transaction along with the temporal indicator associated with the transaction. In some embodiments, the temporal indicator may include a date. The large language model may be further configured to process metadata associated with the communication to determine the identity of the card holder.

In block 306, the override identification system 420 may detect, based on the identity of the card holder, card holder records. The override identification system 420 may extract the card holder records from a database. In other embodiments, the override identification system 420 may detect communication records or card holder records from the card holder or other card holders. In other embodiments, the first machine learning model may include a transformer model that has been trained using communication records regarding card holder records associated with misidentified merchants and mapping to corresponding raw transaction data associated with the historical transactions associated with misidentified merchants. The machine learning model may include of the transformer model that has been trained using historical raw transaction data associated with card holder records that were previously associated with misidentified merchants and corresponding merchant keys stored in the override list.

In block 308, the override identification system 420 may detect, based on the card holder records, the mislabeled name and the temporal indicator, raw data associated with the transaction. In some embodiments, detecting the raw transaction data associated with the plurality of transactions may include performing a fuzzy search of the historical transaction records to detect transaction data comprising raw merchant data that is a fuzzy match to the correct merchant name and that corresponds to one or more customer statement entries associated with the mislabeled merchant name. In other embodiments, the override identification system 420 may modify, based on the merchant key, one or more customer statements comprising the mislabeled merchant name to replace the mislabeled merchant name with one of: raw merchant data derived from the raw transaction data associated with the transaction; and the correct merchant name associated with the transaction.

FIG. 4 is a block diagram of an example override identification system 420 used to determine correct merchant names for the automation of the creation of transaction cleansing overrides according to an example implementation of the disclosed technology. According to some embodiments, the user device 502 and web server 510, as depicted in FIG. 5 and described below, may have a similar structure and components that are similar to those described with respect to override identification system 420 shown in FIG. 4. As shown, the override identification system 420 may include a processor 410, an input/output (I/O) device 470, a memory 430 containing an operating system (OS) 440 and a program 450. In certain example implementations, the override identification system 420 may be a single server or may be configured as a distributed computer system including multiple servers or computers that interoperate to perform one or more of the processes and functionalities associated with the disclosed embodiments. In some embodiments override identification system 420 may be one or more servers from a serverless or scaling server system. In some embodiments, the override identification system 420 may further include a peripheral interface, a transceiver, a mobile network interface in communication with the processor 410, a bus configured to facilitate communication between the various components of the override identification system 420, and a power source configured to power one or more components of the override identification system 420.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 410 to communicate with other devices via wired or wireless networks, whether local or wide area, private or public, as known in the art. A power source may be configured to provide an appropriate alternating current (AC) or direct current (DC) to power components.

The processor 410 may include one or more of a microprocessor, microcontroller, digital signal processor, co-processor or the like or combinations thereof capable of executing stored instructions and operating upon stored data. The memory 430 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 430.

The processor 410 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 410 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 410 may be a single core processor that is configured with virtual processing technologies. In certain embodiments, the processor 410 may use logical processors to simultaneously execute and control multiple processes. The processor 410 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the override identification system 420 may include one or more storage devices configured to store information used by the processor 410 (or other components) to perform certain functions related to the disclosed embodiments. In one example, the override identification system 420 may include the memory 430 that includes instructions to enable the processor 410 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The override identification system 420 may include a memory 430 that includes instructions that, when executed by the processor 410, perform one or more processes consistent with the functionalities disclosed herein. Methods, systems, and articles of manufacture consistent with disclosed embodiments are not limited to separate programs or computers configured to perform dedicated tasks. For example, the override identification system 420 may include the memory 430 that may include one or more programs 450 to perform one or more functions of the disclosed embodiments. For example, in some embodiments, the override identification system 420 may additionally manage dialogue and/or other interactions with the customer via a program 450.

The processor 410 may execute one or more programs 450 located remotely from the override identification system 420. For example, the override identification system 420 may access one or more remote programs that, when executed, perform functions related to disclosed embodiments.

The memory 430 may include one or more memory devices that store data and instructions used to perform one or more features of the disclosed embodiments. The memory 430 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 430 may include software components that, when executed by the processor 410, perform one or more processes consistent with the disclosed embodiments. In some embodiments, the memory 430 may include an override identification system database 460 for storing related data to enable the override identification system 420 to perform one or more of the processes and functionalities associated with the disclosed embodiments.

The override identification system database 460 may include stored data relating to status data (e.g., average session duration data, location data, idle time between sessions, and/or average idle time between sessions) and historical status data. According to some embodiments, the functions provided by the override identification system database 460 may also be provided by a database that is external to the override identification system 420, such as the database 516 as shown in FIG. 5.

The override identification system 420 may also be communicatively connected to one or more memory devices (e.g., databases) locally or through a network. The remote memory devices may be configured to store information and may be accessed and/or managed by the override identification system 420. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The override identification system 420 may also include one or more I/O devices 470 that may include one or more interfaces for receiving signals or input from devices and providing signals or output to one or more devices that allow data to be received and/or transmitted by the override identification system 420. For example, the override identification system 420 may include interface components, which may provide interfaces to one or more input devices, such as one or more keyboards, mouse devices, touch screens, track pads, trackballs, scroll wheels, digital cameras, microphones, sensors, and the like, that enable the override identification system 420 to receive data from a user (such as, for example, via the user device 502).

In examples of the disclosed technology, the override identification system 420 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The override identification system 420 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model including a plurality of models). In some embodiments, training of a model may terminate when a training criterion is satisfied. Training criterion may include a number of epochs, a training time, a performance metric (e.g., an estimate of accuracy in reproducing test data), or the like. The override identification system 420 may be configured to adjust model parameters during training. Model parameters may include weights, coefficients, offsets, or the like. Training may be supervised or unsupervised.

The override identification system 420 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The override identification system 420 may be configured to optimize statistical models using known optimization techniques.

The override identification system 420 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may include combinations of decision tree predictors. (Decision trees may include a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the override identification system may analyze information applying machine-learning methods.

While the override identification system 420 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the override identification system 420 may include a greater or lesser number of components than those illustrated.

FIG. 5 is a block diagram of an example system that may be used to view and interact with transaction processing system 508, according to an example implementation of the disclosed technology. The components and arrangements shown in FIG. 5 are not intended to limit the disclosed embodiments as the components used to implement the disclosed processes and features may vary. As shown, transaction processing system 508 may interact with a user device 502 via a network 506. In certain example implementations, the transaction processing system 508 may include a local network 512, an override identification system 420, a web server 510, and a database 516.

In some embodiments, a user may operate the user device 502. The user device 502 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 506 and ultimately communicating with one or more components of the transaction processing system 508. In some embodiments, the user device 502 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the transaction processing system 508. According to some embodiments, the user device 502 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The override identification system 420 may include programs (scripts, functions, algorithms) to configure data for visualizations and provide visualizations of datasets and data models on the user device 502. This may include programs to generate graphs and display graphs. The override identification system 420 may include programs to generate histograms, scatter plots, time series, or the like on the user device 502. The override identification system 420 may also be configured to display properties of data models and data model training results including, for example, architecture, loss functions, cross entropy, activation function values, embedding layer structure and/or outputs, convolution results, node outputs, or the like on the user device 502.

The network 506 may be of any suitable type, including individual connections via the internet such as cellular or WiFi networks. In some embodiments, the network 506 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 506 may include any type of computer networking arrangement used to exchange data. For example, the network 506 may be the Internet, a private data network, virtual private network (VPN) using a public network, and/or other suitable connection(s) that enable(s) components in the system 500 environment to send and receive information between the components of the system 500. The network 506 may also include a PSTN and/or a wireless network.

The transaction processing system 508 may be associated with and optionally controlled by one or more entities such as a business, corporation, individual, partnership, or any other entity that provides one or more of goods, services, and consultations to individuals such as customers. In some embodiments, the transaction processing system 508 may be controlled by a third party on behalf of another business, corporation, individual, partnership. The transaction processing system 508 may include one or more servers and computer systems for performing one or more functions associated with products and/or services that the organization provides.

Web server 510 may include a computer system configured to generate and provide one or more websites accessible to customers, as well as any other individuals involved in access system 508's normal operations. Web server 510 may include a computer system configured to receive communications from user device 502 via for example, a mobile application, a chat program, an instant messaging program, a voice-to-text program, an SMS message, email, or any other type or format of written or electronic communication. Web server 510 may have one or more processors 522 and one or more web server databases 524, which may be any suitable repository of website data. Information stored in web server 510 may be accessed (e.g., retrieved, updated, and added to) via local network 512 and/or network 506 by one or more devices or systems of system 500. In some embodiments, web server 510 may host websites or applications that may be accessed by the user device 502. For example, web server 510 may host a financial service provider website that a user device may access by providing an attempted login that are authenticated by the override identification system 420. According to some embodiments, web server 510 may include software tools, similar to those described with respect to user device 502 above, that may allow web server 510 to obtain network identification data from user device 502. The web server may also be hosted by an online provider of website hosting, networking, cloud, or backup services, such as Microsoft Azure™ or Amazon Web Services™.

The local network 512 may include any type of computer networking arrangement used to exchange data in a localized area, such as WiFi, Bluetooth™, Ethernet, and other suitable network connections that enable components of the transaction processing system 508 to interact with one another and to connect to the network 506 for interacting with components in the system 500 environment. In some embodiments, the local network 512 may include an interface for communicating with or linking to the network 506. In other embodiments, certain components of the transaction processing system 508 may communicate via the network 506, without a separate local network 506.

The transaction processing system 508 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 502 may be able to access transaction processing system 508 using the cloud computing environment. User device 502 may be able to access transaction processing system 508 using specialized software. The cloud computing environment may eliminate the need to install specialized software on user device 502.

In accordance with certain example implementations of the disclosed technology, the transaction processing system 508 may include one or more computer systems configured to compile data from a plurality of sources the override identification system 420, web server 510, and/or the database 516. The override identification system 420 may correlate compiled data, analyze the compiled data, arrange the compiled data, generate derived data based on the compiled data, and store the compiled and derived data in a database such as the database 516. According to some embodiments, the database 516 may be a database associated with an organization and/or a related entity that stores a variety of information relating to customers, transactions, ATM, and business operations. The database 516 may also serve as a back-up storage device and may contain data and information that is also stored on, for example, database 460, as discussed with reference to FIG. 4.

With continued reference to FIG. 5, the call center server 530 may include a computer system configured to receive, process, and route telephone calls and other electronic communications between a customer or user operating a user device 502 and the override identification system 420. The call center server 530 may have one or more processors 532 and one or more call center databases 534, which may be any suitable repository of call center data. Information stored in the call center server 530 may be accessed (e.g., retrieved, updated, and added to) via the local network 512 (and/or network 506) by one or more devices of the system 500. In some embodiments, the call center server processor 532 may be used to implement an interactive voice response (IVR) system that interacts with the user over the phone or via a voice/audio call portion of an associated mobile application on the user device 502.

Although the preceding description describes various functions of a web server 510, an override identification system 420, a database 516, a call center server 530, and agent device 540 in some embodiments, some or all of these functions may be carried out by a single computing device.

Financial services may be a system associated with a financial service provider, which may be an entity providing financial services. For example, financial services may be associated with a bank, a credit card issuer, or other type of financial service entity that generates, provides, manages, and/or maintains financial service accounts. Financial services may store information about accounts and include, for example, credit card accounts, loan accounts, checking accounts, savings accounts, reward accounts, loyalty program accounts, debit card accounts, cryptocurrency accounts, and/or other types of financial service accounts known to those skilled in the art. Financial services may include infrastructure and components that are configured to generate and/or provide financial service accounts such as credit card accounts, checking accounts, debit card accounts, loyalty or reward programs, lines of credit, and the like. Financial services may authorize or decline credit card authorization requests and may issue authorization codes.

Merchants may include one or more entities that provide goods, services, and/or information, such as a retailer (e.g., Macy's®, Target®, etc.), a grocery store, an entertainment venue (e.g., cinema, theater, museum, etc.), a service provider (e.g.; utility company, etc.), a restaurant, a bar; a non-profit organization (e.g., ACLU™. AARP®, etc.) or other type of entity that provides goods, services, and/or information that consumers (e.g., end-users or other business entities) may purchase, consume, use, etc. Merchants are not limited to entities associated with any particular business, specific industry, or distinct field.

Merchants may include one or more computing systems, such as servers, that are configured to execute stored software instructions to perform operations associated with a merchant, including one or more processes associated with processing purchase transactions, generating transaction data, generating product data (e.g., stock keeping unit (SKU) data) relating to purchase transactions, etc.

In some embodiments, merchants may be brick-and-mortar locations that a consumer may physically visit and purchase goods and services. Such physical locations may include a merchant paying system, which may include computing devices that perform financial service transactions with consumers (e.g., Point-of-Sale (POS) terminal(s), kiosks, etc.). The merchant paying system may include one or more computing devices configured to perform operations consistent with facilitating purchases at merchants. The merchant paying system may also include back- and/or front-end computing components that store data and execute software instructions to perform operations consistent with disclosed embodiments, such as computers that are operated by employees of the merchant (e.g., back-office systems, etc.).

For each purchase, the merchant paying system may collect and/or maintain data detecting the financial card that has been used to make the purchases at merchants. Additionally, the merchant paying system may collect and/or maintain data detecting a customer associated with the financial card and/or data detecting a date on which the purchase was made. The merchant paying system may collect and/or maintain other data as well. Data collected and/or maintained by merchant paying system may be provided to databases 460.

In some embodiments, a payment processor may be used. The payment processor be a device configured to collect credit card information and issue credit card authorizations. Payment processor may be a magnetic stripe reader that collects credit card information and connects with a credit card network. In such embodiments, the payment processor may include software to append information to the credit card authorization or issue new notifications that facilitate hours-of-operation modeling. For example, the payment processor may include a program to flag a credit card authorization, append a time stamp based on a location code (e.g., Zip code T″, and specify the merchant's address.

In some embodiments, to simplify the collection of data, the payment processor may also be connected to databases 460. In such embodiments, the payment processor may include a communication device that sends information to both financial services (i.e., acquirer bank) and databases 460. In such embodiments, when the payment processor is used to complete a credit card transaction, the payment processor may issue a simplified authorization with only time, date, and location. The simplified authorization may then be transmitted to databases 460 and be later used by a prediction system or a model generator. The simplified authorization improves transmission rates and facilitates selection of authorizations for modeling hours of operation. For instance, simplified credit card authorization records may be easier to filter and sort. In yet other embodiments, the payment processor may add information to the credit card authorization for the prediction model. For example, the payment processor may append local time and merchant ID to the authorization before sending it to databases 460 and/or financial services.

Data associated with merchants may include, for example, historical data detecting authorizations associated with financial cards used to make purchases at merchants. A financial card may represent any manner of making a purchase at merchants. A financial card may be, for example, a financial services product associated with a financial service account, such as a bank card, key fob, or smartcard. For example, a financial card may include a credit card, debit card, loyalty card, or other similar financial services product. In some embodiments, a financial card may include a digital wallet or payment application. Thus, a financial card is not limited to a specific physical configuration and may be provided in any form capable of performing the functionality of the disclosed embodiments. In some embodiments, a financial card may include or be included in a mobile device; a wearable item, including jewelry, a smart watch, or any other device suitable for carrying or wearing on a customer's person. Other financial cards are possible as well. Data detecting financial cards used to make purchases at merchants may include, for example, dates on which the purchases were made at merchants and identification of customers associated with the financial cards.

### Example Use Case

The following example use case describes an example of a typical user flow pattern. This section is intended solely for explanatory purposes and not in limitation.

In one example, a customer John conducts a transaction by purchasing a pair of shoes on Amazon using a debit card from a financial provider. The financial provider sends a financial statement to John with the transaction of the pair of shoes. The transaction lists eBay as the merchant name for the transaction. John then sends a communication to a financial provider by calling the call center. During the phone call, John states his name along with a complaint of the misnaming of the merchant on his transaction. The call center 530 can store the call as call data in the call center server 530. The override identification system 420 may analyze the call data using a first machine learning model to determine John's identity, detect the transaction related to eBay, and detect a date associated with the transaction. The override identification system 420 may detect raw transaction data by using John's name, the merchant name of eBay and the date of the transaction. Additionally, the override identification system 420 may generate, using a second machine learning model, a merchant key based on the raw transaction data, and modify an override list to add the merchant key. This merchant key can later be used to update other financial statements that accidently listed eBay instead of Amazon as a merchant on a transaction.

In some examples, disclosed systems or methods may involve one or more of the following clauses:
Clause 1: A system comprising: one or more processors; and a memory in communication with the one or more processors and storing instructions that, when executed by the one or more processors, are configured to cause the system to: receive a communication from a card holder via one of one or more communication channels; analyze the communication using a first machine learning model to: determine an identity of the card holder; detect a mislabeled name associated with an entry; and detect a date associated with the entry; detect, based on the identity of the card holder, historical entry records of the card holder; detect, based on the historical entry records of the card holder, the mislabeled name associated with the entry and the date associated with the entry, raw entry data associated with the entry; generate, using a second machine learning model, a key based on the raw entry data; alter an override list to add the key by: determining whether the key substantially matches one of stored keys in the override list; in response to determining the key does not substantially match one of the stored keys in the override list, storing the key in the override list; and storing an updated name associated with the key in the override list; transmit a request to a user device associated with the card holder that asks the card holder to provide an indication of a correct identity associated with the entry; and responsive to receiving a response to the request that includes the indication of the correct identity associated with the entry, alter a statement of the card holder to replace the mislabeled name associated with the entry with the correct identity.
Clause 2: The system of claim 1, wherein the one or more communication channels comprise one or more of: emails; messages via a website form; chat messages; text messages; and call logs of service calls.
Clause 3: The system of claim 1, wherein the first machine learning model is configured to monitor and analyze communications via the one or more communication channels in near real time.
Clause 4: The system of claim 1, wherein the first machine learning model comprises a large language model that is configured to process a message of the communication to detect the mislabeled name associated with the entry.
Clause 5: The system of claim 4, wherein the large language model is further configured to process metadata associated with the communication to determine the identity of the card holder.
Clause 6: The system of claim 1, wherein the raw entry data comprises data stored in one or more data fields, wherein the one or more data fields comprises one or more of: a name field; a state field; a zip code field; a country code field; and a category code.
Clause 7: The system of claim 6, wherein the key is generated based on the data stored in the one or more data fields.
Clause 8: The system of claim 1, wherein the first machine learning model comprises a transformer model that has been trained using historical communication data regarding historical entries associated with incorrect names and mapping to corresponding raw entry data associated with the historical entries associated with incorrect names.
Clause 9: The system of claim 1, wherein the second machine learning model comprises a transformer model that has been trained using historical raw entry data associated with historical entries that were previously associated with incorrect names and corresponding keys stored in the override list.
Clause 10: The system of claim 1, wherein the instructions are further configured to cause the system to: receive present entry data, wherein the present entry data comprises entry data originating from use of a card at a device of a first entity and represents an entry that is in the process of attempting to execute; detecting a policy associated with the card, wherein the policy restricts procurements from one or more predetermined entities, wherein the one or more predetermined entities comprise at least the first entity; determining that the present entry data comprises data corresponding to the key, wherein the key is associated with the first entity; responsive to the present entry data being received prior to a modification of the override list to add the key, decline the entry; and responsive to the present entry data being received after to the modification of the override list to add the key: transmit a request to a user device associated with the card requesting an identification of an entity associated with the entry; and responsive to receiving an indication from the user device that the entity associated with the entry is the first entity, approve the entry.
Clause 11: A system comprising: one or more processors; and a memory in communication with the one or more processors and storing instructions that, when executed by the one or more processors, are configured to cause the system to: receive a communication via one of one or more communication channels; analyze the communication using a first machine learning model to: detect a mislabeled name associated with an entry; and detect a correct name associated with the entry; detect, based on a plurality of historical entry records, the mislabeled name associated with the entry and the correct name associated with the entry, raw entry data associated with the entry; generate, using a second machine learning model, a key based on the raw entry data; alter an override list to add the key by: determining whether the key substantially matches one of stored keys in the override list; in response to determining the key does not substantially match one of the stored keys in the override list, storing the key in the override list; and storing an updated name associated with the key in the override list; and alter, based on the key, a statement comprising the mislabeled name to replace the mislabeled name with one of: raw data derived from the raw entry data associated with the entry; and the correct name associated with the entry.
Clause 12: The system of claim 11, wherein detecting the raw entry data associated with the entry comprises performing a fuzzy search of the plurality of historical entry records to detect entry data comprising raw data that is a fuzzy match to the correct name and that corresponds to a statement entry associated with the mislabeled name.
Clause 13: The system of claim 12, wherein the first machine learning model comprises a large language model that is configured to process a message of the communication to detect the mislabeled name associated with the entry and the correct name associated with the entry.
Clause 14: The system of claim 13, wherein the first machine learning model comprises a transformer model that has been trained using historical communication data regarding historical entries associated with incorrect names and a mapping to corresponding raw entry data associated with the historical entries associated with incorrect names.
Clause 15: A system comprising: one or more processors; and a memory in communication with the one or more processors and storing instructions that, when executed by the one or more processors, are configured to cause the system to: receive a communication via one of one or more communication channels; analyze the communication using a first machine learning model to: detect a mislabeled name associated with an entry; and detect a correct name associated with the entry; detect, based on a plurality of historical entry records, the mislabeled name associated with the entry and the correct name associated with the entry, raw entry data associated with a plurality of entries; generate, using a second machine learning model, a key based on the raw entry data; and alter an override list to add the key by: determining whether the key substantially matches one of stored keys in the override list; in response to determining the key does not substantially match one of the stored keys in the override list, storing the key in the override list; and storing an updated name associated with the key in the override list.
Clause 16: The system of claim 15, wherein detecting the raw entry data associated with the plurality of entries comprises performing a fuzzy search of the historical entry records to detect entry data comprising raw data that is a fuzzy match to the correct name and that corresponds to one or more statement entries associated with the mislabeled name.
Clause 17: The system of claim 16, wherein the instructions are further configured to cause the system to: alter, based on the key, one or more statements comprising the mislabeled name to replace the mislabeled name with one of: raw data derived from the raw entry data associated with the entry; and the correct name associated with the entry.
Clause 18: The system of claim 15, wherein the first machine learning model comprises a large language model that is configured to process a message of the communication to detect the mislabeled name associated with the entry and the correct name associated with the entry.
Clause 19: The system of claim 15, wherein the instructions are further configured to cause the system to: transmit a request to a user device via the one of one or more communication channels to provide an indication of a correct identity associated with the entry; and responsive to receiving a response to the request that includes the indication of the correct identity associated with the entry, alter a statement of a card holder to replace the mislabeled name associated with the entry with the correct identity.
Clause 20: The system of claim 15, wherein the raw entry data comprises data stored in one or more data fields, wherein the one or more data fields comprises one or more of: a name field; a state field; a zip code field; a country code field; and a category code.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive a communication from a card holder via one of one or more communication channels;
analyze the communication using a first machine learning model to:
determine an identity of the card holder;
detect a mislabeled name associated with an entry; and
detect a date associated with the entry;
detect, based on the identity of the card holder, historical entry records of the card holder;
detect, based on the historical entry records of the card holder, the mislabeled name associated with the entry and the date associated with the entry, raw entry data associated with the entry;
generate, using a second machine learning model, a key based on the raw entry data;
alter an override list to add the key by:
determining whether the key substantially matches one of stored keys in the override list;
in response to determining the key does not substantially match one of the stored keys in the override list, storing the key in the override list; and
storing an updated name associated with the key in the override list;
transmit a request to a user device associated with the card holder that asks the card holder to provide an indication of a correct identity associated with the entry; and
responsive to receiving a response to the request that includes the indication of the correct identity associated with the entry, alter a statement of the card holder to replace the mislabeled name associated with the entry with the correct identity.

2. The system of claim 1, wherein the one or more communication channels comprise one or more of:
emails;
messages via a website form;
chat messages;
text messages; and
call logs of service calls.

3. The system of claim 1, wherein the first machine learning model is configured to monitor and analyze communications via the one or more communication channels in near real time.

4. The system of claim 1, wherein the first machine learning model comprises a large language model that is configured to process a message of the communication to detect the mislabeled name associated with the entry.

5. The system of claim 4, wherein the large language model is further configured to process metadata associated with the communication to determine the identity of the card holder.

6. The system of claim 1, wherein the raw entry data comprises data stored in one or more data fields, wherein the one or more data fields comprises one or more of:
a name field;
a state field;
a zip code field;
a country code field; and
a category code.

7. The system of claim 6, wherein the key is generated based on the data stored in the one or more data fields.

8. The system of claim 1, wherein the first machine learning model comprises a transformer model that has been trained using historical communication data regarding historical entries associated with incorrect names and mapping to corresponding raw entry data associated with the historical entries associated with incorrect names.

9. The system of claim 1, wherein the second machine learning model comprises a transformer model that has been trained using historical raw entry data associated with historical entries that were previously associated with incorrect names and corresponding keys stored in the override list.

10. The system of claim 1, wherein the instructions are further configured to cause the system to:
receive present entry data, wherein the present entry data comprises entry data originating from use of a card at a device of a first entity and represents an entry that is in the process of attempting to execute;
detecting a policy associated with the card, wherein the policy restricts procurements from one or more predetermined entities, wherein the one or more predetermined entities comprise at least the first entity;
determining that the present entry data comprises data corresponding to the key, wherein the key is associated with the first entity;
responsive to the present entry data being received prior to a modification of the override list to add the key, decline the entry; and
responsive to the present entry data being received after to the modification of the override list to add the key:
transmit a request to a user device associated with the card requesting an identification of an entity associated with the entry; and
responsive to receiving an indication from the user device that the entity associated with the entry is the first entity, approve the entry.

11. A system comprising:
one or more processors; and
a memory in communication with the one or more processors and storing instructions that, when executed by the one or more processors, are configured to cause the system to:
receive a communication via one of one or more communication channels;
analyze the communication using a first machine learning model to:
detect a mislabeled name associated with an entry; and
detect a correct name associated with the entry;
detect, based on a plurality of historical entry records, the mislabeled name associated with the entry and the correct name associated with the entry, raw entry data associated with the entry;
generate, using a second machine learning model, a key based on the raw entry data;
alter an override list to add the key by:
determining whether the key substantially matches one of stored keys in the override list;
in response to determining the key does not substantially match one of the stored keys in the override list, storing the key in the override list; and
storing an updated name associated with the key in the override list; and
alter, based on the key, a statement comprising the mislabeled name to replace the mislabeled name with one of:
raw data derived from the raw entry data associated with the entry; and
the correct name associated with the entry.

12. The system of claim 11, wherein detecting the raw entry data associated with the entry comprises performing a fuzzy search of the plurality of historical entry records to detect entry data comprising raw data that is a fuzzy match to the correct name and that corresponds to a statement entry associated with the mislabeled name.

13. The system of claim 12, wherein the first machine learning model comprises a large language model that is configured to process a message of the communication to detect the mislabeled name associated with the entry and the correct name associated with the entry.

14. The system of claim 13, wherein the first machine learning model comprises a transformer model that has been trained using historical communication data regarding historical entries associated with incorrect names and a mapping to corresponding raw entry data associated with the historical entries associated with incorrect names.

15. A system comprising:
one or more processors; and
a memory in communication with the one or more processors and storing instructions that, when executed by the one or more processors, are configured to cause the system to:
receive a communication via one of one or more communication channels;
analyze the communication using a first machine learning model to:
detect a mislabeled name associated with an entry; and
detect a correct name associated with the entry;
detect, based on a plurality of historical entry records, the mislabeled name associated with the entry and the correct name associated with the entry, raw entry data associated with a plurality of entries;
generate, using a second machine learning model, a key based on the raw entry data; and
alter an override list to add the key by:
determining whether the key substantially matches one of stored keys in the override list;
in response to determining the key does not substantially match one of the stored keys in the override list, storing the key in the override list; and
storing an updated name associated with the key in the override list.

16. The system of claim 15, wherein detecting the raw entry data associated with the plurality of entries comprises performing a fuzzy search of the historical entry records to detect entry data comprising raw data that is a fuzzy match to the correct name and that corresponds to one or more statement entries associated with the mislabeled name.

17. The system of claim 16, wherein the instructions are further configured to cause the system to:
alter, based on the key, one or more statements comprising the mislabeled name to replace the mislabeled name with one of:
raw data derived from the raw entry data associated with the entry; and
the correct name associated with the entry.

18. The system of claim 15, wherein the first machine learning model comprises a large language model that is configured to process a message of the communication to detect the mislabeled name associated with the entry and the correct name associated with the entry.

19. The system of claim 15, wherein the instructions are further configured to cause the system to:
transmit a request to a user device via the one of one or more communication channels to provide an indication of a correct identity associated with the entry; and
responsive to receiving a response to the request that includes the indication of the correct identity associated with the entry, alter a statement of a card holder to replace the mislabeled name associated with the entry with the correct identity.

20. The system of claim 15, wherein the raw entry data comprises data stored in one or more data fields, wherein the one or more data fields comprises one or more of:
a name field;
a state field;
a zip code field;
a country code field; and
a category code.
